(19) United States
(12) Patent Application Publication
(10) Pub. No.: US 2024/0248300 A1
(43) Pub. Date: Jul. 25, 2024

(54) OPTICAL SYSTEM AND DISPLAY APPARATUS

(71) Applicant: CANON KABUSHIKI KAISHA, Tokyo (JP)

(72) Inventors: Keigo YARITA, Tokyo (JP); Yu MIYAJIMA, Tochigi (JP); Kazuto ISHIDA, Tochigi (JP); Yuma KOBAYASHI, Tochigi (JP)

(21) Appl. No.: 18/531,918

(22) Filed: Dec. 7, 2023

(30) Foreign Application Priority Data
Jan. 24, 2023 (JP) 2023-008501

(51) Int. Cl. G02B 27/00; G02B 13/18

(52) U.S. Cl. CPC G02B 27/0081; G02B 13/18

(57) ABSTRACT

An optical system includes, in order from a pupil surface side to a display surface side, a first lens having a first transmissive reflective surface on the pupil surface side, a second lens, and a third lens having a second transmissive reflective surface on the display surface side. The second lens is cemented with the first or third lens. The light beam from the display surface transmits through the second transmissive reflective surface, transmits through the third, second, and first lenses in this order, is reflected by the first transmissive reflective surface, transmits through the first, second, and third lenses in this order, is reflected by the second transmissive reflective surface, transmits through the third, second, and first lenses in this order, transmits through the first transmissive reflective surface, and enters the pupil surface.

### BACKGROUND

### Technical Field

One of the aspects of the embodiments relates to an optical system and a display apparatus.

### Description of Related Art

A display apparatus (observation apparatus) such as a head mount display (HMD) has recently been known which provide a realistic experience by enlarging and displaying an original image displayed using a display element such as a liquid crystal display (LCD) via an observation optical system and presenting a large screen image to the user. Since the display apparatus is attached to the user's head and used, the observation optical system that is used for the display apparatus is demanded to have a small (thin) size, a wide field of view, and high optical performance. Japanese Patent Laid-Open No. 2022-88582 discloses an optical system that has three lenses and a reflective polarizer placed on a surface on the display surface side of a lens closest to a pupil.

In the optical system disclosed in Japanese Patent Laid-Open No. 2022-88582, the reflective polarizer is disposed between the lens surfaces and thus the size reduction is difficult. On the other hand, if the number of lenses is reduced to two for miniaturization, it becomes difficult to correct chromatic aberration and thus to achieve high optical performance.

### SUMMARY

An optical system according to one aspect of the embodiment is configured to guide a light beam from a display surface to a pupil surface. The optical system includes, in order from a pupil surface side to a display surface side, a first lens having a first transmissive reflective surface on the pupil surface side, a second lens, and a third lens having a second transmissive reflective surface on the display surface side. The second lens is cemented with the first lens or the third lens. The light beam from the display surface transmits through the second transmissive reflective surface, transmits through the third lens, the second lens, and the first lens in this order, is reflected by the first transmissive reflective surface, transmits through the first lens, the second lens, and the third lens in this order, is reflected by the second transmissive reflective surface, transmits through the third lens, the second lens, and the first lens in this order, transmits through the first transmissive reflective surface, and enters the pupil surface. A display apparatus having the above optical system also constitutes another aspect of the embodiment.

Further features of the disclosure will become apparent from the following description of embodiments with reference to the attached drawings.

### BRIEF DESCRIPTION OF THE DRAWINGS

FIG. 1 schematically illustrates an optical path of an optical system.

FIG. 2 schematically illustrates an optical path of another optical system.

FIGS. 3A and 3B are a sectional view and aberration diagram of an optical system according to Example 1.

FIGS. 4A and 4B are a sectional view and aberration diagram of an optical system according to Example 2.

FIGS. 5A and 5B are a sectional view and aberration diagram of the optical system according to Example 2.

FIGS. 6A and 6B are a sectional view and aberration diagram of the optical system according to Example 2.

FIGS. 7A and 7B are a sectional view and aberration diagram of an optical system according to Example 3.

FIGS. 8A and 8B are a sectional view and aberration diagram of an optical system according to Example 4.

FIGS. 9A and 9B are a sectional view and aberration diagram of an optical system according to Example 5.

FIGS. 10A and 10B are a sectional view and aberration diagram of an optical system according to Example 6.

FIGS. 11A and 11B are a sectional view and aberration diagram of an optical system according to Example 7.

FIGS. 12A and 12B are a sectional view and aberration diagram of an optical system according to Example 8.

### DESCRIPTION OF THE EMBODIMENTS

Referring now to the accompanying drawings, a detailed description will be given of examples.

The optical system according to each example is an optical system configured to guide a light beam from a display surface of a display element to an observation surface (pupil surface), and is an observation optical system configured to enable a user to observe an image displayed on the display surface. A display apparatus includes the optical system according to each example and a display element. The optical system according to each example includes a first lens, a second lens, and a third lens in this order from the pupil surface side (observation side) to the display surface side. A surface on the pupil surface side of the first lens is a first transmissive reflective surface. A surface on the display surface side of the third lens is a second transmissive reflective surface. A quarter waveplate may be placed at an arbitrary position between the first transmissive reflective surface and the second transmissive reflective surface.

The light beam from the display surface first transmits through the second transmissive reflective surface, transmits through the third lens, second lens, and first lens in this order, and is reflected by the first transmissive reflective surface. Then, it transmits through the first lens, second lens, and third lens in this order, is reflected by the second transmissive reflective surface, transmits through the third lens, second lens, and first lens in this order, transmits through the first transmissive reflective surface, and enters the pupil surface. Thereby, the optical system according to each example can enable the user to observe an optical image of the display surface from the pupil where the exit pupil is located. In each example, the light following the above optical path is desired light, and the others are unnecessary light.

In each example, the first transmissive reflective surface is placed on the observation surface side of the first lens, and the second transmissive reflective surface is placed on the display surface side of the third lens. This configuration can increase the length of the optical path that the light reciprocates through, and as a result, and consequently make thinner the optical system. Moreover, for further thinning, the second lens is cemented with the first lens or the third lens. Providing a difference in Abbe number between the second lens and the lens cemented to the second lens (first lens or third lens) can sufficiently correct chromatic aberration.

More specifically, in a case where the second lens is cemented with the third lens, and the following inequality (1) may be satisfied:

$$\vert vd 3 - vd 2 \vert > 5. \qquad ( 1 )$$

where vd2 is an Abbe number of the second lens based on the d-line, and vd3 is an Abbe number of the third lens based on the d-line.

Satisfying inequality (1) can perform sufficient color correction even if either Abbe number vd2 or vd3 is large. In a case where the value becomes lower than the lower limit of inequality (1), chromatic aberration is not sufficiently corrected, resolution decreases, and the user's sense of immersion is thereby impaired.

Inequality (1) may be replaced with inequality (1a), (1b), or (1c) below:

$$\vert vd 3 - vd 2 \vert > 10. \qquad ( 1 a )$$

$$\vert vd 3 - vd 2 \vert > 15. \qquad ( 1 b )$$

$$\vert vd 3 - vd 2 \vert > 20.0 \qquad ( 1 c )$$

Similarly, in a case where the second lens is cemented to the first lens, the following inequality (2) may be satisfied:

$$\vert vd 1 - vd 2 \vert > 5. \qquad ( 2 )$$

where vd1 is an Abbe number of the first lens based on the d-line.

Inequality (2) may be replaced with inequality (2a), (2b), or (2c) below:

$$\vert vd 1 - vd 2 \vert > 10. \qquad ( 2 a )$$

$$\vert vd 1 - vd 2 \vert > 15. \qquad ( 2 b )$$

$$\vert vd 1 - vd 2 \vert > 20.0 \qquad ( 2 c )$$

In each example, the following inequality (3) may be satisfied:

$$0.60 < L 1 / F < 1. \qquad ( 3 )$$

where L1 is a distance from a surface on the observation surface side of the first lens to the display surface, and F is a focal length of the optical system (the entire system).

The distance L1 is not an optical path length, but a straight-line distance on the optical axis from the surface on the observation surface side of the first lens to the display surface. In a case where the value becomes higher than the upper limit of inequality (3), the focal length becomes long for the optical system, the display surface needs to become larger to further widen the viewing angle, as a result, the display element becomes larger, and the size of the optical system cannot be sufficiently reduced. On the other hand, in a case where the value becomes lower than the lower limit of inequality (3), it is necessary to increase the refractive power of the surface as the transmissive reflective surface, but due to the strong refractive power only on a specific surface, aberration correction becomes difficult, and it becomes difficult to obtain sufficient resolution.

Inequality (3) may be replaced with inequality (3a) or (3b) below:

$$0.65 < L 1 / F < 0 \text{.97} \qquad ( 3 a )$$

$$0.7 < L 1 / F < 0.92 \qquad ( 3 b )$$

In each example, at least one surface (lens surface) of the first lens, second lens, or third lens may have a curvature on the optical axis that is different from a curvature near the end of the effective diameter, or has an aspheric surface having an inflection point. This configuration can facilitate correction of lateral chromatic aberration, and provide an optical system with higher resolving power. Furthermore, the transmissive reflective surface as an aspherical surface having an inflection point can adjust the reflection angle of the light beam at the end of the viewing angle, and reduce the lens diameter. In order to facilitate processing such as attaching a quarter waveplate, which will be described below, at least one surface of the first lens, second lens, or third lens may be made flat.

In each example, the following inequality (4) may be satisfied:

$$0.25 < L 1 / D < 0.50 \qquad ( 4 )$$

where D is the largest effective diameter among the first lens, second lens, and third lens.

In a case where the value becomes higher than the upper limit of inequality (4), the viewing angle tends to become narrower, the sense of immersion tends to lower, and the optical system becomes larger in the optical axis direction in order to expand the viewing angle. On the other hand, in a case where the value becomes lower than the lower limit of inequality (4), if the display surface is small, a ray exit angle relative to the normal line of the display surface becomes large, and the luminance tends to become dark. To avoid this, it is necessary to increase the size of the display surface, and the weight of the display apparatus increases.

Inequality (4) may be replaced with inequality (4a) or (4b) below:

$$0.28 < L 1 / D < 0.45 \qquad ( 4 a )$$

$$0.3 < L 1 / D < 0.42 \qquad ( 4 b )$$

In each example, the distance L1 may be 40 mm or less. In a case where the distance L1 becomes longer than 40 mm, it is inconvenient when each example optical system is mounted on an HMD or the like and attached to the user's head. In a case where a camera is attached to the front of the HMD to image the outside world and display the image on the display unit, the parallax increases, and the user may easily feel sick or uncomfortable. The distance L1 may be 30 mm or less or 25 mm or less.

Each example can perform diopter adjustment by moving the third lens or both the second lens and the third lens in the optical axis direction. Depending on the embodiment, the diopter adjustment may be made by moving the display surface in the optical axis direction. If the second lens and the third lens are moved, controlling at least one of a moving amount or direction of each lens can reduce magnification fluctuations during focusing and diopter adjustment. In each example, the half viewing angle may be 35° or more. This configuration provides the user with a higher sense of immersion.

In each example, it is expected that the first transmissive reflective surface is placed on the observation surface side and may be touched by the user. Therefore, a protective film or a separate protective member may be placed on the observation surface side of the first transmissive reflective surface. The protective member may be a member having a nearly flat shape so as not to affect the optical performance of the optical system according to each example. The material of the protective member is not limited, and may be glass or resin, and the linear polarizer may be protected by a film structure in order to reduce ghost light in a specific polarization state.

As described below, a polarization-selective transmissive reflective element (reflective polarizer) may be used as the first transmissive reflective surface. The polarization selective transmissive reflective element may use, for example, product name “WGF” manufactured by Asahi Kasei Corporation. Such a film-shaped polarizing element can be applied to a curved surface, but placing it in a flat or nearly flat shape can reduce risks of axial direction shift, a surface shape change, and poor appearance due to stress when the film is bent.

The display surface corresponds to a display element (light modulation element) such as a liquid crystal display element or an organic EL element, and the display element includes a polarizing plate and a second quarter waveplate in addition to the display surface. The shape of the display element is a square with a diagonal of 1.6 inches (28.7 mm on each side). A polarizing plate and a second quarter waveplate are arranged close to each other in this order from the display element to the pupil side.

In each example, the following configuration can suppress the decrease in light intensity of the regular observation optical path and reduce ghost light (unnecessary light leakage) from the optical path that transmits through the half transmissive surface without being reflected even once.

### Configuration 1 Utilizing Polarization

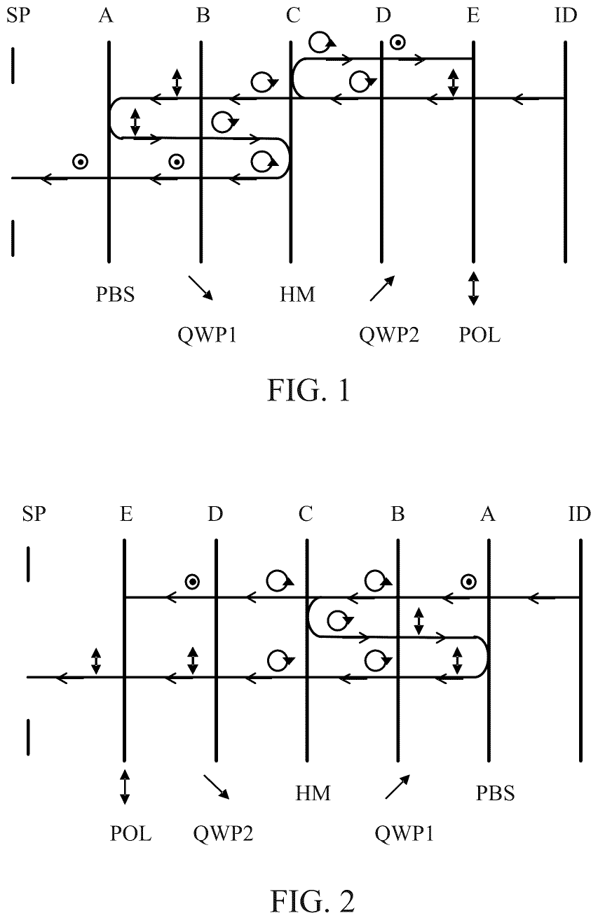

Referring now to FIG. 1, a description will be given of a configuration utilizing polarization. The optical system with this configuration has two transmissive reflective surfaces. Here, the transmissive reflective surface disposed on the observation side of the optical system according to this configuration includes polarization-selective transmissive reflective element (PBS) A. The polarization-selective transmissive reflective element (PBS) is a polarizer (reflective polarizer) configured to separate (split) incident light into reflected light and transmitting light according to the polarization state. The transmissive reflective surface disposed on the display element side of the optical system according to this configuration includes half-mirror (HM) C. First quarter waveplate (QWP1) B is placed between the polarization-selective transmissive reflective element PBS and the half-mirror HM. Second quarter waveplate (QWP2) D and linear polarizing plate (POL) E are disposed between the half-mirror HM and the display surface ID.

Here, the polarization-selective transmissive reflective element A is an element configured to reflect linearly polarized light polarized in the same direction as that when transmitting through the linear polarizing plate E, and transmit linearly polarized light orthogonal to this direction. The polarization-selective transmissive reflective element is, for example, a wire grid polarizer or a reflective polarizer having a layered structure of retardation films. At this time, the wire grid forming surface or the retardation film surface of the polarization-selective transmissive reflective element A functions as a transmissive reflective surface. The wire grid polarizer does not necessarily have to be made of aligned metal wires, but can be anything that has thin metal or dielectric layers at predetermined intervals and functions as a polarization-selective transmissive reflective element. For example, an element with aligned metal or dielectric layers as described above can be used.

The first quarter waveplate B and the second quarter waveplate D are arranged with their slow axes tilted by 45 degrees relative to the polarization transmission axis of the linear polarizing plate E. Here, the first quarter waveplate B and the second quarter waveplate D may be disposed with their respective slow axes tilted by 90 degrees. This arrangement can cancel out the wavelength dispersion characteristics of these waveplates in a case where a light beam transmits through the first quarter waveplate B and the second quarter waveplate D. The half-mirror C is a half-mirror formed, for example, by a dielectric multilayer film or metal vapor deposition, and functions as a transmissive reflective surface. The linear polarizing plate E is, for example, an absorption type linear polarizer.

A description will now be given of the optical path selection and operation in the configuration utilizing polarization. The light emitted from the display surface ID becomes linearly polarized light by the linear polarizing plate E, becomes circularly polarized light by the second quarter waveplate D, and enters the half-mirror C. Part of the light that reaches the half-mirror C is reflected, becomes circularly polarized light in the opposite direction, and returns to the second quarter waveplate D. The circularly polarized light in the opposite direction that has returned to the second quarter waveplate D returns to the linear polarizing plate E as linearly polarized light polarized by the second quarter waveplate D in a direction orthogonal to that when first transmitting through the linear polarizing plate E and is absorbed by the linear polarizing plate E. On the other hand, part of the light that reaches the half-mirror C transmits through the half-mirror C and becomes linearly polarized light by the first quarter waveplate B in the same direction as that when transmitting through the linear polarizing plate E, and enters the polarization-selective transmissive reflective element A.

Here, due to the polarization selectivity of the polarization-selective transmissive reflective element A, the linearly polarized light polarized in the same direction as that when transmitting through the linear polarizing plate E is reflected. The light reflected by the polarization-selective transmissive reflective element A becomes circularly polarized light in the same as that when it first became circularly polarized light by the second quarter waveplate D and the first quarter waveplate B, and enters the half-mirror C. The light reflected by the half-mirror C becomes circularly polarized light in the opposite direction to that of the pre-reflection light, enters the first quarter waveplate B, becomes linearly polarized light polarized in a direction orthogonal to that when it first transmits through the linear polarizing plate E, and enters the polarization-selective transmissive reflective element A. Here, due to the polarization selectivity of the polarization-selective transmissive reflective element A, linearly polarized light polarized in a direction orthogonal to that when transmitting through the linear polarizing plate E transmits through it and is guided to the pupil surface SP.

Due to the above actions, only the light that has transmitted through the half-mirror HM, been reflected by the polarization-selective transmissive reflective element PBS, been reflected by the half-mirror HM, and transmitted through the polarization-selective transmissive reflective element PBS is guided to the pupil surface SP.

### Configuration 2 Utilizing Polarization

Referring now to FIG. 2, a description will be given of a configuration utilizing polarization. The optical system with this configuration has two transmissive reflective surfaces. Here, the transmissive reflective surface disposed on the observation side of the optical system according to this configuration includes a half-mirror (HM) C. The transmissive reflective surface disposed on the display element side of the optical system according to this configuration includes a polarization-selective transmissive reflective element (PBS) A. A first quarter waveplate (QWP1) B is disposed between the polarization-selective transmissive reflective element PBS and the half-mirror HM. A linear polarizing plate (POL) E and a second quarter waveplate (QWP2) D are disposed between the half-mirror HM and the pupil surface SP. In this configuration, the configuration of each polarizing element and the arrangement of the optical axis direction are the same as those of configuration 1 described above.

A description will now be given of the optical path selection and operation in the configuration utilizing polarization. Due to the polarization-selective transmissive reflective element A, the light emitted from the display surface ID becomes linearly polarized light polarized in a direction orthogonal to the transmission axis of the linear polarizing plate E, and transmits through the polarization-selective transmissive reflective element A. The light that has transmitted through the polarization-selective transmissive reflective element A becomes circularly polarized light by the first quarter waveplate B, and enters the half-mirror C. Part of the light that reaches the half-mirror C transmits through it and enters the second quarter waveplate D. The circularly polarized light that has entered the second quarter waveplate D then enters the linear polarizing plate E as linearly polarized light polarized in a direction orthogonal to the transmission axis of the linear polarizing plate E by the second quarter waveplate D, and is absorbed by the linear polarizing plate E. On the other hand, part of the light that has reached the half-mirror C is reflected, becomes circularly polarized light in the opposite direction, and returns to the first quarter waveplate B. The circularly polarized light in the opposite direction that has returned to the first quarter waveplate B becomes linearly polarized light polarized in a direction parallel to the transmission axis of the linear polarizing plate E by the first quarter waveplate B, and enters the polarization-selective transmissive reflective element A.

Here, due to the polarization selectivity of the polarization-selective transmissive reflective element A, the linearly polarized light polarized in a direction parallel to the transmission axis of the linear polarizing plate E is reflected. The light reflected by the polarization-selective transmissive reflective element A becomes circularly polarized light in the opposite direction to the circularly polarized light produced by the first quarter waveplate B, and enters the half-mirror C. Here, the light that has transmitted through the half-mirror C enters the second quarter waveplate D, becomes linearly polarized light polarized in a direction parallel to the transmission axis of the linear polarizing plate E, transmits through the linear polarizing plate E, and is guided to the pupil surface SP.

Due to the above actions, only the light that has transmitted through the polarization-selective transmissive reflective element PBS, been reflected by the half-mirror HM, been reflected by the polarization-selective transmissive reflective element PBS, and transmitted through the half-mirror HM is guided to the pupil surface SP.

A description will now be given of the configuration of the optical system according to each example. In each example, numerical values and optical path diagrams for polarizing plates, quarter waveplates, polarization-selective transmissive reflective elements, etc. are omitted.

### Example 1

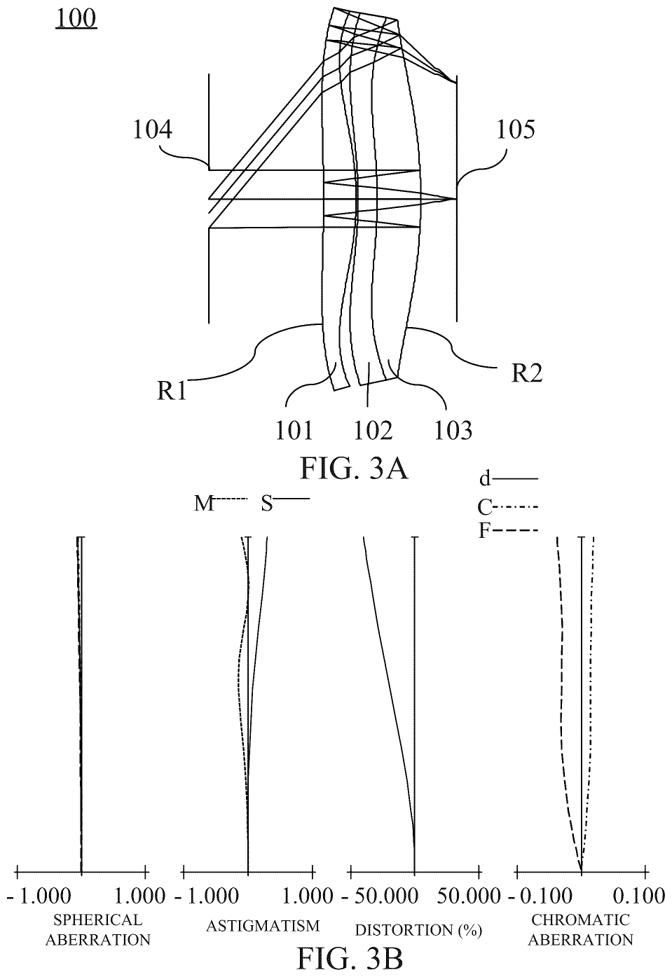

Referring now to FIGS. 3A and 3B, a description will be given of an optical system (observation optical system) 100 according to Example 1. FIG. 3A is a sectional view of optical system 100. The optical system 100 includes a first lens 101, a second lens 102, and a third lens 103 in this order from the observation surface (pupil surface) 104 side to the display surface 105 side. The first lens 101 has a first transmissive reflective surface R1 on the surface on the observation surface 104 side. The third lens 103 has a second transmissive reflective surface R2 on the surface on the display surface 105 side. In the optical system 100, the second lens 102 and the third lens 103 are cemented. FIG. 3B is an aberration diagram of the optical system 100 for the wavelengths of the d-line, F-line, and C-line in a case where a virtual image is displayed at a position of 1600 mm from the observation surface 104 and an eye relief is 12 mm.

### Example 2

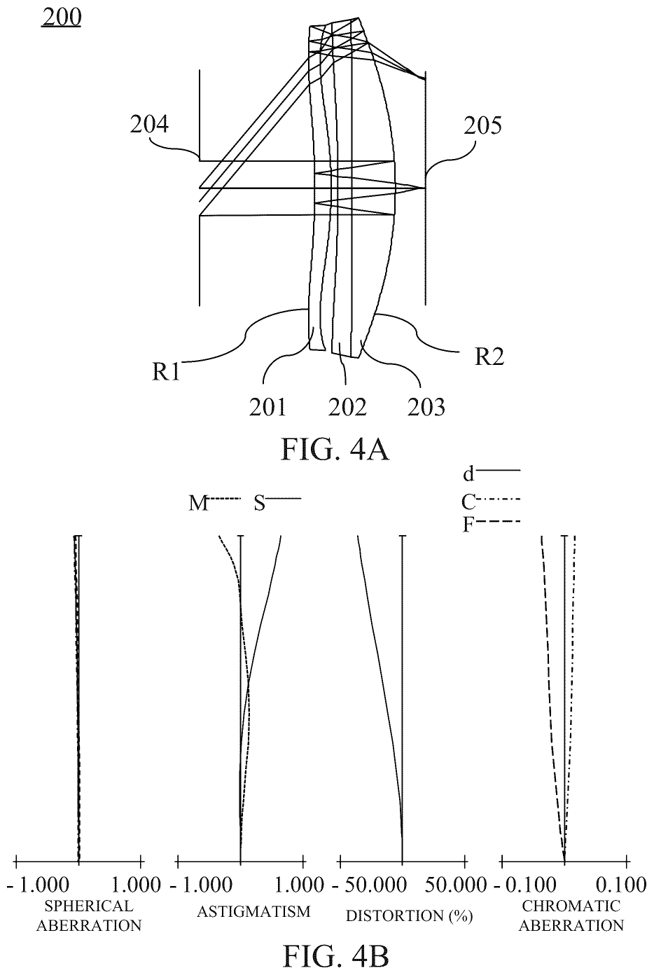

Referring now to FIGS. 4A, 4B, 5A, 5B, and 6A, 6B, a description will be given of an optical system (observation optical system) 200 according to Example 2. FIG. 4A is a sectional view of optical system 200. The optical system 200 includes a first lens 201, a second lens 202, and a third lens 203 in this order from the observation surface (pupil surface) 204 side to the display surface 205 side. The first lens 201 has a first transmissive reflective surface R1 on the observation surface 204 side. The third lens 203 has a second transmissive reflective surface R2 on the surface on the display surface 205 side. In the optical system 200, the second lens 202 and the third lens 203 are cemented. FIG. 4B is an aberration diagram of the optical system 200 for the wavelengths of the d-line, F-line, and C-line when a virtual image is displayed at a position of 1600 mm from the observation surface 104 and an eye relief is 12 mm.

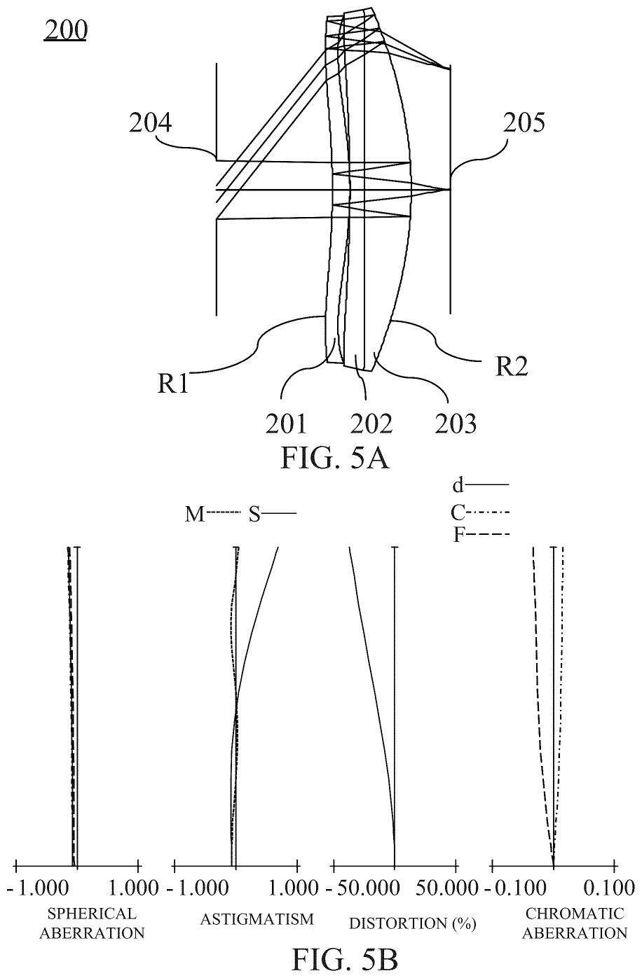

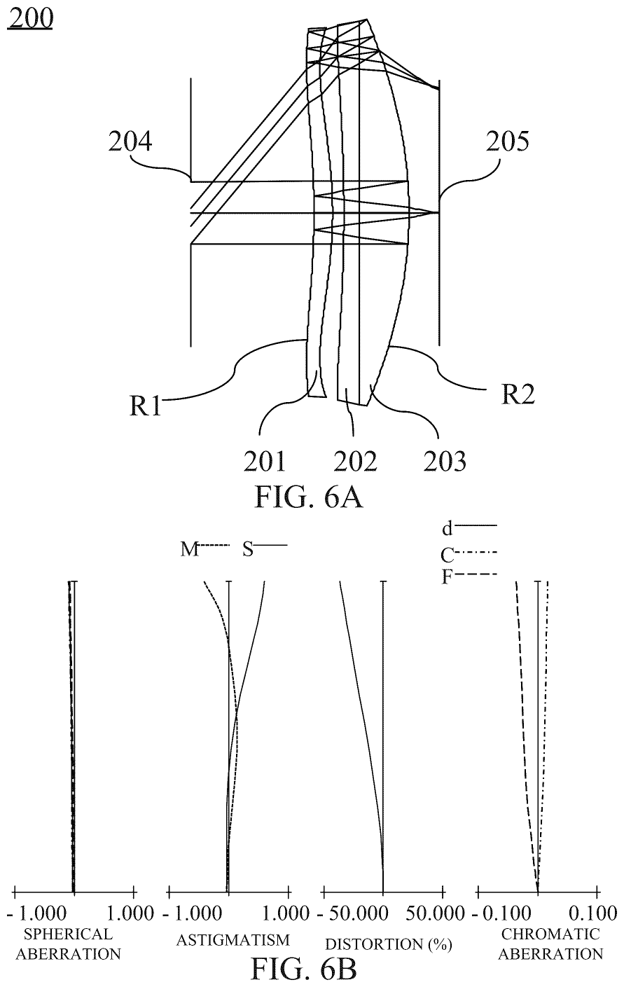

The optical system 200 according to this example has an unillustrated diopter adjustment mechanism, and can provide diopter adjustment that provides focusing according to the user's sight by adjusting the distance between the cemented lens of the second lens 202 and the third lens 203 and the first lens 201. FIG. 5A is an optical path diagram of the optical system 200 in a case where diopter adjustment corresponding to −5D (diopter) is made for a nearsighted user. FIG. 5B is an aberration diagram corresponding to FIG. 5A. FIG. 6A is an optical path diagram of the optical system 200 in the case of diopter adjustment corresponding to +1D is made for a farsighted user. FIG. 6B is an aberration diagram corresponding to FIG. 6A.

In this example, the distance between the first lens 201 and the third lens 203 changes during the diopter adjustment, but is not limited to this implementation. For example, the distance between the third lens 203 and the display surface 205 may be changed.

### Example 3

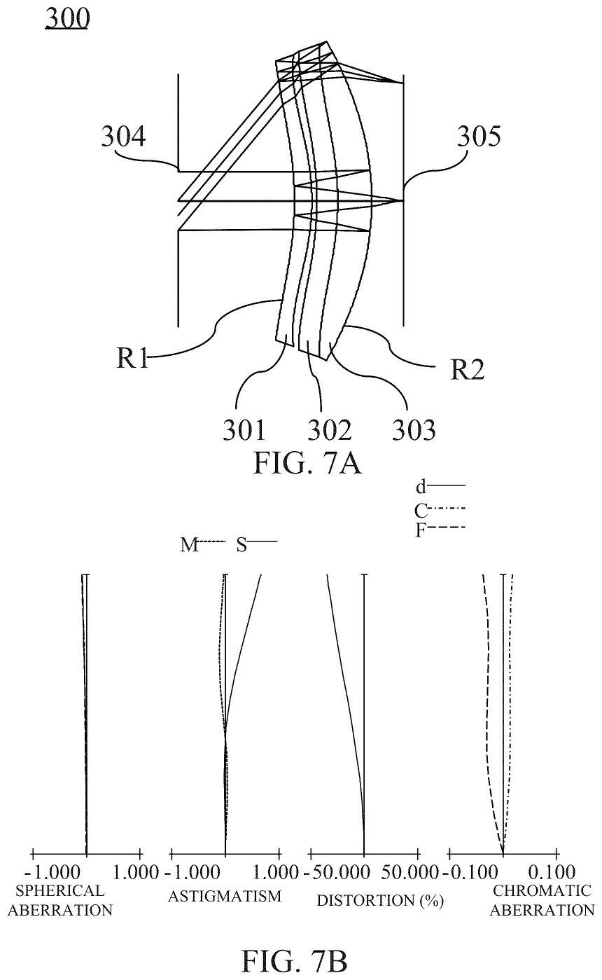

Referring now to FIGS. 7A and 7B, a description will be given of an optical system (observation optical system) 300 according to Example 3. FIG. 7A is a sectional view of optical system 300. The optical system 300 includes a first lens 301, a second lens 302, and a third lens 303 in this order from the observation surface (pupil surface) 304 side to the display surface 305 side. The first lens 301 has a first transmissive reflective surface R1 on the surface on the observation surface 304 side. The third lens 303 has a second transmissive reflective surface R2 on the surface on the display surface 305 side. In the optical system 300, the second lens 302 and the third lens 303 are cemented. FIG. 7B is an aberration diagram of the optical system 300 for the wavelengths of the d-line, F-line, and C-line in a case where a virtual image is displayed at a position of 1600 mm from the observation surface 304 and an eye relief is 12 mm.

### Example 4

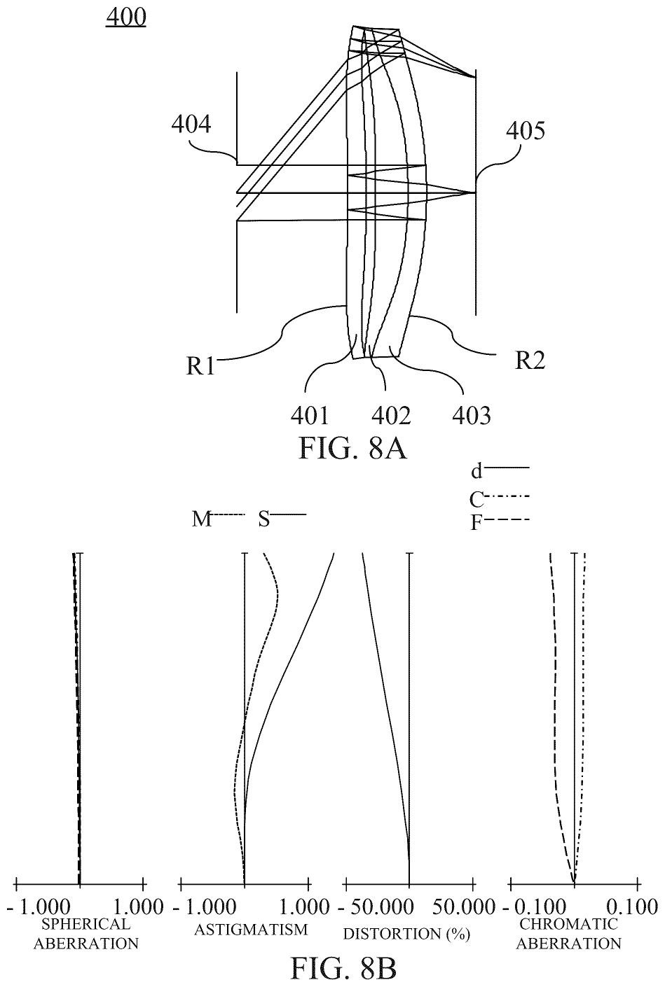

Referring now to FIGS. 8A and 8B, a description will be given of an optical system (observation optical system) 400 according to Example 4. FIG. 8A is a sectional view of optical system 400. The optical system 400 includes a first lens 401, a second lens 402, and a third lens 403 in this order from the observation surface (pupil surface) 404 side to the display surface 405 side. The first lens 401 has a first transmissive reflective surface R1 on the observation surface 404 side. The third lens 403 has a second transmissive reflective surface R2 on the surface on the display surface 405 side. In the optical system 400, the second lens 402 and the third lens 403 are cemented. FIG. 8B is an aberration diagram of the optical system 400 for the wavelengths of the d-line, F-line, and C-line in a case where a virtual image is displayed at a position of 1600 mm from the observation surface 404 and an eye relief is 12 mm.

### Example 5

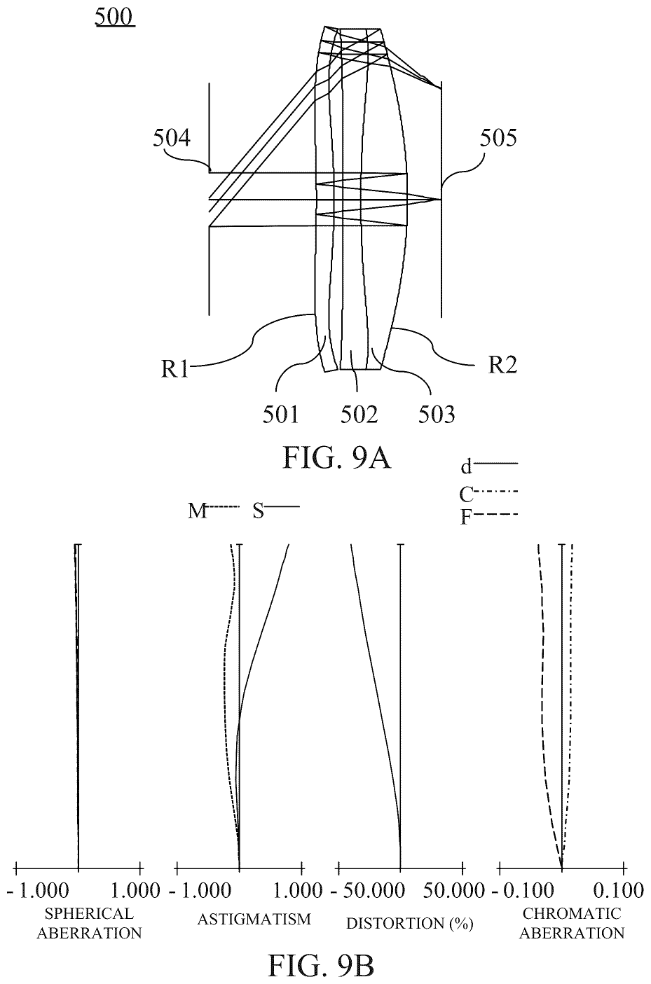

Referring now to FIGS. 9A and 9B, a description will be given of an optical system (observation optical system) 500 according to Example 5. FIG. 9A is a sectional view of optical system 500. The optical system 500 includes a first lens 501, a second lens 502, and a third lens 503 in this order from the observation surface (pupil surface) 504 side to the display surface 505 side. The first lens 501 has a first transmissive reflective surface R1 on the observation surface 504 side. The third lens 503 has a second transmissive reflective surface R2 on the surface on the display surface 505 side. In the optical system 500, the second lens 502 and the third lens 503 are cemented. FIG. 9B is an aberration diagram of the optical system 500 for the wavelengths of the d-line, F-line, and C-line in a case where a virtual image is displayed at a position of 1600 mm from the observation surface 504 and an eye relief is 12 mm.

### Example 6

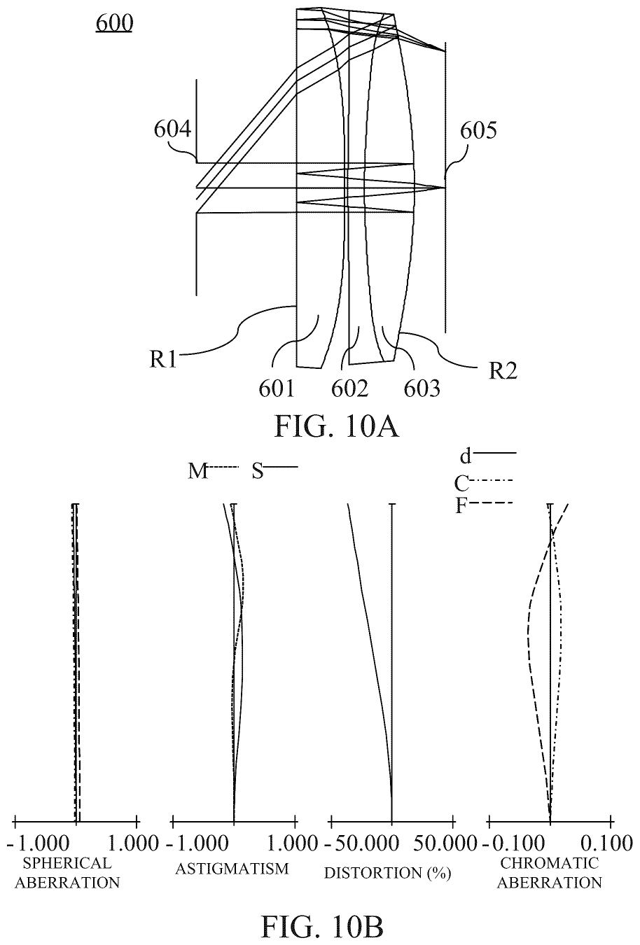

Referring now to FIGS. 10A and 10B, a description will be given of an optical system (observation optical system) 600 according to Example 6. FIG. 10A is a sectional view of optical system 600. The optical system 600 includes a first lens 601, a second lens 602, and a third lens 603 in this order from the observation surface (pupil surface) 604 side to the display surface 605 side. The first lens 601 has a first transmissive reflective surface R1 on the observation surface 604 side. The third lens 603 has a second transmissive reflective surface R2 on the surface on the display surface 605 side. In the optical system 600, the second lens 602 and the third lens 603 are cemented. FIG. 10B is an aberration diagram of the optical system 600 for the wavelengths of the d-line, F-line, and C-line in a case where a virtual image is displayed at a position of 1600 mm from the observation surface 604 and an eye relief is 12 mm.

### Example 7

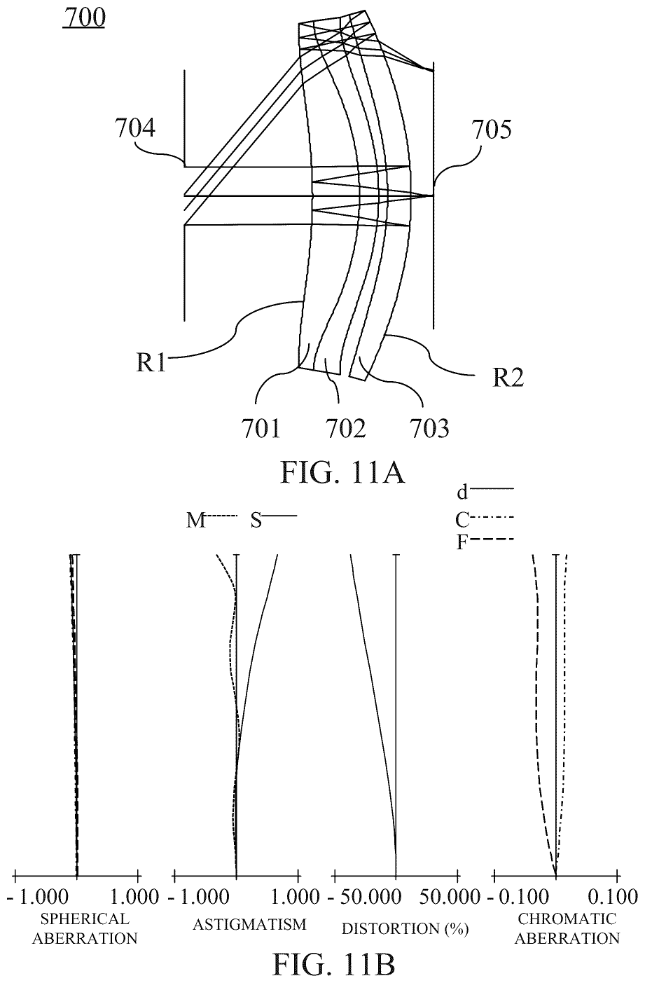

Referring now to FIGS. 11A and 11B, a description will be given of an optical system (observation optical system) 700 according to Example 7. FIG. 11A is a sectional view of optical system 700. The optical system 700 includes a first lens 701, a second lens 702, and a third lens 703 in this order from the observation surface (pupil surface) 704 side to the display surface 705 side. The first lens 701 has a first transmissive reflective surface R1 on the observation surface 704 side. The third lens 703 has a second transmissive reflective surface R2 on the surface on the display surface 705 side. In the optical system 700, the first lens 701 and the second lens 702 are cemented. FIG. 11B is an aberration diagram of the optical system 700 for the wavelengths of the d-line, F-line, and C-line in a case where the virtual image is displayed at a position of 1600 mm from the observation surface 704 and an eye relief is 12 mm.

### Example 8

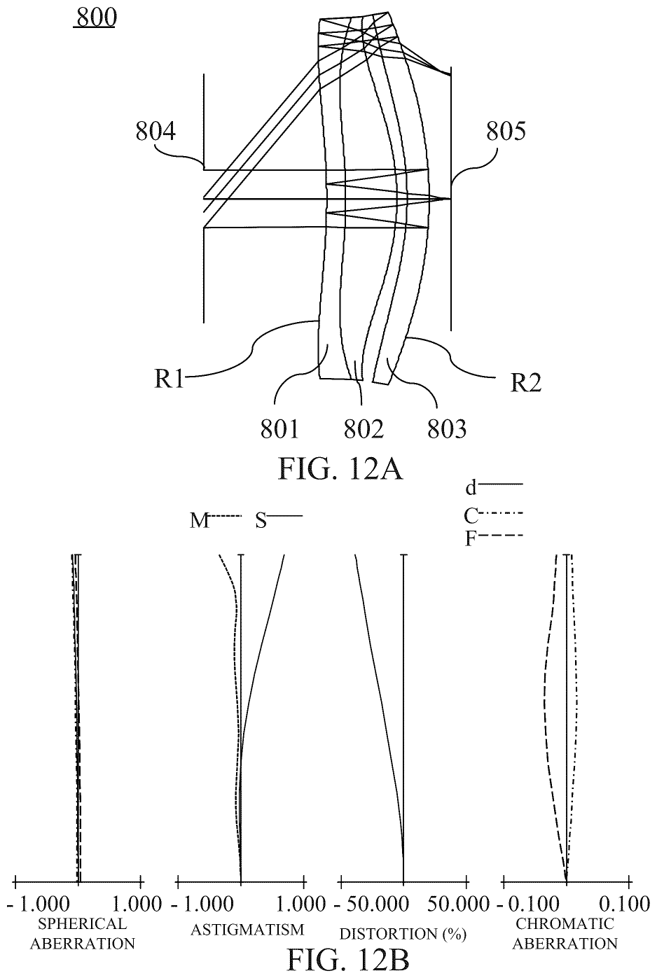

Referring now to FIGS. 12A and 12B, a description will be given of an optical system (observation optical system) 800 according to Example 8. FIG. 12A is a sectional view of optical system 800. The optical system 800 includes a first lens 801, a second lens 802, and a third lens 803 in this order from the observation surface (pupil surface) 804 side to the display surface 805 side. The first lens 801 has a first transmissive reflective surface R1 on the observation surface 804 side. The third lens 803 has a second transmissive reflective surface R2 on the surface on the display surface 805 side. In the optical system 800, the first lens 801 and the second lens 802 are cemented. FIG. 12B is an aberration diagram of the optical system 800 for the wavelengths of the d-line, F-line, and C-line in a case where the virtual image is displayed at a position of 1600 mm from the observation surface 804 and an eye relief is 12 mm.

A description will now be given of numerical examples 1 to 8 corresponding to Examples 1 to 8, respectively. In the surface data of each numerical example, a surface number i indicates an i-th surface counted from the pupil surface side. r represents a radius of curvature of the i-th surface (mm), d represents a lens thickness or air gap (mm) between i-th and (i+1)-th surfaces, and nd represents a refractive index for the d-line of the material of the i-th optical member. vd represents an Abbe number of the material of the i-th optical element based on the d-line. The Abbe number vd of a certain material is expressed as follows:

$$\\ vd = ( Nd - 1 ) / ( NF - NC )$$

where Nd, NF, and NC are refractive indices based on the d-line (587.6 nm), the F-line (486.1 nm), and the C-line (656.3 nm) in the Fraunhofer line, respectively. The effective diameter indicates a maximum diameter of an area through which light from an original image transmits on each surface.

In a case where the optical surface is aspherical, an asterisk * is attached to the right side of the surface number. The aspherical shape is expressed as follows:

$$x ( h ) = \frac{( \frac{{h}^{2}}{r} )}{1 + \sqrt{\{ 1 - ( 1 + k ) {( \frac{h}{r} )}^{2} \}}} + {A}_{4} {h}^{4} + {A}_{6} {h}^{6} + {A}_{8} {h}^{8} + {A}_{10} {h}^{10} + …$$

where x is a displacement amount from a surface vertex in the optical axis direction, h is a height from the optical axis in a direction orthogonal to the optical axis, R is a paraxial radius of curvature, k is a conic constant, and Ai (where i=4, 6, 8, . . . ) are aspheric coefficients.

### Numerical Example 1

UNIT: mm
SURFACE DATA

| | | | | | Effective |
|---|---|---|---|---|---|
| Surface No. | r | d | nd | νd | Diameter |
| 1 (Pupil Surface) | ∞ | (Variable) | | | 4.00 |
| 2* | −166.111 | 3.41 | 1.53500 | 55.7 | 28.81 |
| 3* | −29.279 | 0.20 | | | 30.55 |
| 4* | −44.306 | 2.00 | 1.64220 | 22.4 | 33.81 |
| 5* | −46.858 | 4.55 | 1.53500 | 55.7 | 36.10 |
| 6* | −52.957 | −4.55 | 1.53500 | 55.7 | 37.42 |
| 7* | −46.858 | −2.00 | 1.64220 | 22.4 | 37.86 |
| 8* | −44.306 | −0.20 | | | 38.94 |
| 9* | −29.279 | −3.41 | 1.53500 | 55.7 | 39.21 |
| 10* | −166.111 | 3.41 | 1.53500 | 55.7 | 40.00 |
| 11* | −29.279 | 0.20 | | | 38.63 |
| 12* | −44.306 | 2.00 | 1.64220 | 22.4 | 37.69 |
| 13* | −46.858 | 4.55 | 1.53500 | 55.7 | 35.69 |
| 14* | −52.957 | (Variable) | | | 34.27 |
| Image Plane | ∞ | | | | |

ASPHERIC DATA
2nd Surface
K = 0.00000e+00 A 4 = 1.45332e−05
3rd Surface
K = 0.00000e+00 A 4 = 4.85156e−05 A 6 = −5.29835e−09
4th Surface
K = 0.00000e+00 A 4 = 4.38365e−05 A 6 = −2.89638e−08
5th Surface
K = 0.00000e+00 A 4 = 5.51420e−05 A 6 = −4.66561e−08
6th Surface
K = 0.00000e+00 A 4 = 4.08912e−06 A 6 = 1.13085e−08
7th Surface
K = 0.00000e+00 A 4 = 5.51420e−05 A 6 = −4.66561e−08
8th Surface
K = 0.00000e+00 A 4 = 4.38365e−05 A 6 = −2.89638e−08
9th Surface
K = 0.00000e+00 A 4 = 4.85156e−05 A 6 = −5.29835e−09
10th Surface
K = 0.00000e+00 A 4 = 1.45332e−05
11th Surface
K = 0.00000e+00 A 4 = 4.85156e−05 A 6 = −5.29835e−09
12th Surface
K = 0.00000e+00 A 4 = 4.38365e−05 A 6 = −2.89638e−08
13th Surface
K = 0.00000e+00 A 4 = 5.51420e−05 A 6 = −4.66561e−08
14th Surface
K = 0.00000e+00 A 4 = 4.08912e−06 A 6 = 1.13085e−08
VARIOUS DATA
Zoom Ratio 1.00
FOCAL LENGTH 16.89

### Numerical Example 2

UNIT: mm
SURFACE DATA

| | | | | | Effective |
|---|---|---|---|---|---|
| Surface No. | r | d | nd | νd | Diameter |
| 1 (Pupil Surface) | ∞ | (Variable) | | | 4.00 |
| 2* | −73.684 | 1.80 | 1.53500 | 55.7 | 28.80 |
| 3* | −43.689 | (Variable) | | | 30.34 |
| 4* | −163.414 | 1.50 | 1.64220 | 22.4 | 34.09 |
| 5 | ∞ | 4.83 | 1.53500 | 55.7 | 36.61 |
| 6* | −42.072 | −4.83 | 1.53500 | 55.7 | 37.59 |
| 7 | ∞ | −1.50 | 1.64220 | 22.4 | 37.28 |
| 8* | −163.414 | (Variable) | | | 36.46 |
| 9* | −43.689 | −1.80 | 1.53500 | 55.7 | 35.95 |
| 10* | −73.684 | 1.80 | 1.53500 | 55.7 | 35.70 |
| 11* | −43.689 | (Variable) | | | 34.71 |
| 12* | −163.414 | 1.50 | 1.64220 | 22.4 | 34.02 |
| 13 | ∞ | 4.83 | 1.53500 | 55.7 | 33.15 |
| 14* | −42.072 | (Variable) | | | 32.37 |
| 15 | ∞ | (Variable) | | | 40.00 |
| Image Plane | ∞ | | | | |

ASPHERIC DATA
2nd Surface
K = 0.00000e+00 A 4 = 1.64018e−05
3rd Surface
K = 0.00000e+00 A 4 = 2.37294e−05 A 6 = 2.24874e−08
4th Surface
K = 0.00000e+00 A 4 = 2.10185e−08 A 6 = 1.04216e−08
6th Surface
K = 0.00000e+00 A 4 = 1.83596e−06 A 6 = 2.94316e−09
8th Surface
K = 0.00000e+00 A 4 = 2.10185e−08 A 6 = 1.04216e−08
9th Surface
K = 0.00000e+00 A 4 = 2.37294e−05 A 6 = 2.24874e−08
10th Surface
K = 0.00000e+00 A 4 = 1.64018e−05
11th Surface
K = 0.00000e+00 A 4 = 2.37294e−05 A 6 = 2.24874e−08
12th Surface
K = 0.00000e+00 A 4 = 2.10185e−08 A 6 = 1.04216e−08
14th Surface
K = 0.00000e+00 A 4 = 1.83596e−06 A 6 = 2.94316e−09
VARIOUS DATA
Zoom Ratio 1.00
FOCAL LENGTH 15.89

### Numerical Example 3

UNIT: mm
SURFACE DATA

| | | | | | Effective |
|---|---|---|---|---|---|
| Surface No. | r | d | nd | νd | Diameter |
| 1 (Pupil Surface) | ∞ | (Variable) | | | 4.00 |
| 2* | −32.459 | 1.80 | 1.53500 | 55.7 | 24.88 |
| 3* | −22.838 | (Variable) | | | 26.88 |
| 4* | −31.363 | 2.15 | 1.64220 | 22.4 | 29.01 |
| 5* | −28.344 | 3.51 | 1.53500 | 55.7 | 31.75 |
| 6* | −29.122 | −3.51 | 1.53500 | 55.7 | 32.90 |
| 7* | −28.344 | −2.15 | 1.64220 | 22.4 | 32.26 |
| 8* | −31.363 | (Variable) | | | 30.73 |
| 9* | −22.838 | −1.80 | 1.53500 | 55.7 | 30.02 |
| 10* | −32.459 | 1.80 | 1.53500 | 55.7 | 28.80 |
| 11* | −22.838 | (Variable) | | | 28.58 |
| 12* | −31.363 | 2.15 | 1.64220 | 22.4 | 28.51 |
| 13* | −28.344 | 3.51 | 1.53500 | 55.7 | 28.46 |
| 14* | −29.122 | (Variable) | | | 28.39 |
| 15 | ∞ | (Variable) | | | 40.00 |
| Image Plane | ∞ | | | | |

ASPHERIC DATA
2nd Surface
K = 0.00000e+00 A 4 = 3.90975e−05 A 6 = −2.75121e−08
3rd Surface
K = 0.00000e+00 A 4 = 7.22028e−05 A 6 = 6.16810e−09
4th Surface
K = 0.00000e+00 A 4 = 3.70210e−05 A 6 = 5.18165e−09
5th Surface
K = 0.00000e+00 A 4 = 5.81857e−05 A 6 = −4.82852e−08
6th Surface
K = 0.00000e+00 A 4 = 2.70714e−06 A 6 = 1.24931e−08
7th Surface
K = 0.00000e+00 A 4 = 5.81857e−05 A 6 = −4.82852e−08
8th Surface
K = 0.00000e+00 A 4 = 3.70210e−05 A 6 = 5.18165e−09
9th Surface
K = 0.00000e+00 A 4 = 7.22028e−05 A 6 = 6.16810e−09
10th Surface
K = 0.00000e+00 A 4 = 3.90975e−05 A 6 = −2.75121e−08
11th Surface
K = 0.00000e+00 A 4 = 7.22028e−05 A 6 = 6.16810e−09
12th Surface
K = 0.00000e+00 A 4 = 3.70210e−05 A 6 = 5.18165e−09
13th Surface
K = 0.00000e+00 A 4 = 5.81857e−05 A 6 = −4.82852e−08
14th Surface
K = 0.00000e+00 A 4 = 2.70714e−06 A 6 = 1.24931e−08
VARIOUS DATA
Zoom Ratio 1.00
FOCAL LENGTH 15.62

### Numerical Example 4

UNIT: mm
SURFACE DATA

| | | | | | Effective |
|---|---|---|---|---|---|
| Surface No. | r | d | nd | νd | Diameter |
| 1 (Pupil Surface) | ∞ | (Variable) | | | 4.00 |
| 2* | −155.664 | 2.00 | 1.63550 | 23.9 | 28.78 |
| 3* | −137.180 | 1.02 | | | 30.18 |
| 4* | −336.499 | 3.50 | 1.54390 | 56.0 | 31.28 |
| 5* | −51.176 | 2.00 | 1.63550 | 23.9 | 32.50 |
| 6* | −46.863 | −2.00 | 1.63550 | 23.9 | 35.43 |
| 7* | −51.176 | −3.50 | 1.54390 | 56.0 | 35.63 |
| 8* | −336.499 | −1.02 | | | 35.70 |
| 9* | −137.180 | −2.00 | 1.63550 | 23.9 | 35.69 |
| 10* | −155.664 | 2.00 | 1.63550 | 23.9 | 36.11 |
| 11* | −137.180 | 1.02 | | | 35.30 |
| 12* | −336.499 | 3.50 | 1.54390 | 56.0 | 35.30 |
| 13* | −51.176 | 2.00 | 1.63550 | 23.9 | 34.93 |
| 14* | −46.863 | (Variable) | | | 33.79 |
| 15 | ∞ | (Variable) | | | 40.00 |
| Image Plane | ∞ | | | | |

ASPHERIC DATA
2nd Surface
K = 0.00000e+00 A 4 = 1.52789e−05
3rd Surface
K = 0.00000e+00 A 4 = −3.36595e−06 A 6 = 4.19894e−08
4th Surface
K = 0.00000e+00 A 4 = −2.16210e−05 A 6 = 4.44719e−08
5th Surface
K = 0.00000e+00 A 4 = −3.76394e−05 A 6 = 9.58210e−08
6th Surface
K = 0.00000e+00 A 4 = −1.81118e−07 A 6 = 1.50317e−08
7th Surface
K = 0.00000e+00 A 4 = −3.76394e−05 A 6 = 9.58210e−08
8th Surface
K = 0.00000e+00 A 4 = −2.16210e−05 A 6 = 4.44719e−08
9th Surface
K = 0.00000e+00 A 4 = −3.36595e−06 A 6 = 4.19894e−08
10th Surface
K = 0.00000e+00 A 4 = 1.52789e−05
11th Surface
K = 0.00000e+00 A 4 = −3.36595e−06 A 6 = 4.19894e−08
12th Surface
K = 0.00000e+00 A 4 = −2.16210e−05 A 6 = 4.44719e−08
13th Surface
K = 0.00000e+00 A 4 = −3.76394e−05 A 6 = 9.58210e−08
14th Surface
K = 0.00000e+00 A 4 = −1.81118e−07 A 6 = 1.50317e−08
VARIOUS DATA
Zoom Ratio 1.00
FOCAL LENGTH 16.64

### Numerical Example 5

UNIT: mm
SURFACE DATA

| | | | | | Effective |
|---|---|---|---|---|---|
| Surface No. | r | d | nd | νd | Diameter |
| 1 (Pupil Surface) | ∞ | (Variable) | | | 4.00 |
| 2* | −163.997 | 2.00 | 1.63550 | 23.9 | 28.83 |
| 3* | −78.480 | 1.00 | | | 30.23 |
| 4* | 53235.337 | 2.00 | 1.63550 | 23.9 | 33.31 |
| 5* | 121.998 | 5.24 | 1.54390 | 56.0 | 36.54 |
| 6* | −55.515 | −5.24 | 1.54390 | 56.0 | 38.30 |
| 7* | 121.998 | −2.00 | 1.63550 | 23.9 | 38.32 |
| 8* | 53235.337 | −1.00 | | | 38.30 |
| 9* | −78.480 | −2.00 | 1.63550 | 23.9 | 38.31 |
| 10* | −163.997 | 2.00 | 1.63550 | 23.9 | 38.82 |
| 11* | −78.480 | 1.00 | | | 37.56 |
| 12* | 53235.337 | 2.00 | 1.63550 | 23.9 | 37.11 |
| 13* | 121.998 | 5.24 | 1.54390 | 56.0 | 35.42 |
| 14* | −55.515 | (Variable) | | | 34.23 |
| 15 | ∞ | (Variable) | | | 40.00 |
| Image Plane | ∞ | | | | |

ASPHERIC DATA
2nd Surface
K = 0.00000e+00 A 4 = 1.47659e−05
3rd Surface
K = 0.00000e+00 A 4 = 1.47589e−05 A 6 = 1.69250e−08
4th Surface
K = 0.00000e+00 A 4 = −3.94058e−06 A 6 = 4.69716e−09
5th Surface
K = 0.00000e+00 A 4 = 4.09732e−06 A 6 = −3.01633e−08
6th Surface
K = 0.00000e+00 A 4 = 1.49244e−06 A 6 = 3.69260e−09
7th Surface
K = 0.00000e+00 A 4 = 4.09732e−06 A 6 = −3.01633e−08
8th Surface
K = 0.00000e+00 A 4 = −3.94058e−06 A 6 = 4.69716e−09
9th Surface
K = 0.00000e+00 A 4 = 1.47589e−05 A 6 = 1.69250e−08
10th Surface
K = 0.00000e+00 A 4 = 1.47659e−05
11th Surface
K = 0.00000e+00 A 4 = 1.47589e−05 A 6 = 1.69250e−08
12th Surface
K = 0.00000e+00 A 4 = −3.94058e−06 A 6 = 4.69716e−09
13th Surface
K = 0.00000e+00 A 4 = 4.09732e−06 A 6 = −3.01633e−08
14th Surface
K = 0.00000e+00 A 4 = 1.49244e−06 A 6 = 3.69260e−09
VARIOUS DATA
Zoom Ratio 1.00
FOCAL LENGTH 17.45

### Numerical Example 6

UNIT: mm
SURFACE DATA

| | | | | | Effective |
|---|---|---|---|---|---|
| Surface No. | r | d | nd | νd | Diameter |
| 1 (Pupil Surface) | ∞ | (Variable) | | | 4.00 |
| 2 | ∞ | 5.83 | 1.53500 | 55.7 | 28.87 |
| 3* | −324.719 | 0.37 | | | 34.06 |
| 4* | 289.479 | 2.00 | 1.64220 | 22.4 | 37.05 |
| 5* | 93.889 | 6.00 | 1.53500 | 55.7 | 40.26 |
| 6* | −77.026 | −6.00 | 1.53500 | 55.7 | 41.76 |
| 7* | 93.889 | −2.00 | 1.64220 | 22.4 | 41.90 |
| 8* | 289.479 | −0.37 | | | 42.63 |
| 9* | −324.719 | −5.83 | 1.53500 | 55.7 | 43.51 |
| 10 | ∞ | 5.83 | 1.53500 | 55.7 | 43.14 |
| 11* | −324.719 | 0.37 | | | 42.74 |
| 12* | 289.479 | 2.00 | 1.64220 | 22.4 | 40.44 |
| 13* | 93.889 | 6.00 | 1.53500 | 55.7 | 38.91 |
| 14* | −77.026 | (Variable) | | | 38.04 |
| 15 | ∞ | (Variable) | | | 40.00 |
| Image Plane | ∞ | | | | |

ASPHERIC DATA
3rd Surface
K = 0.00000e+00 A 4 = −1.20191e−05 A 6 = 5.03609e−09
4th Surface
K = 0.00000e+00 A 4 = −6.38087e−06 A 6 = 7.56195e−09
5th Surface
K = 0.00000e+00 A 4 = −1.36234e−05 A 6 = 3.11142e−08
6th Surface
K = 0.00000e+00 A 4 = 2.02494e−06 A 6 = 1.83510e−10
7th Surface
K = 0.00000e+00 A 4 = −1.36234e−05 A 6 = 3.11142e−08
8th Surface
K = 0.00000e+00 A 4 = −6.38087e−06 A 6 = 7.56195e−09
9th Surface
K = 0.00000e+00 A 4 = −1.20191e−05 A 6 = 5.03609e−09
11th Surface
K = 0.00000e+00 A 4 = −1.20191e−05 A 6 = 5.03609e−09
12th Surface
K = 0.00000e+00 A 4 = −6.38087e−06 A 6 = 7.56195e−09
13th Surface
K = 0.00000e+00 A 4 = −1.36234e−05 A 6 = 3.11142e−08
14th Surface
K = 0.00000e+00 A 4 = 2.02494e−06 A 6 = 1.83510e−10
VARIOUS DATA
Zoom Ratio 1.00
FOCAL LENGTH 21.58

### Numerical Example 7

UNIT: mm
SURFACE DATA

| | | | | | Effective |
|---|---|---|---|---|---|
| Surface No. | r | d | nd | νd | Diameter |
| 1 (Pupil Surface) | ∞ | (Variable) | | | 4.00 |
| 2* | −52.471 | 4.88 | 1.53500 | 55.7 | 28.82 |
| 3* | −29.351 | 2.00 | 1.64220 | 22.4 | 31.25 |
| 4* | −25.060 | (Variable) | | | 34.08 |
| 5* | −29.799 | 2.45 | 1.64220 | 22.4 | 36.39 |
| 6* | −36.954 | −2.45 | 1.64220 | 22.4 | 38.51 |
| 7* | −29.799 | (Variable) | | | 37.59 |
| 8* | −25.060 | −2.00 | 1.64220 | 22.4 | 37.08 |
| 9* | −29.351 | −4.88 | 1.53500 | 55.7 | 36.22 |
| 10* | −52.471 | 4.88 | 1.53500 | 55.7 | 35.73 |
| 11* | −29.351 | 2.00 | 1.64220 | 22.4 | 35.07 |
| 12* | −25.060 | (Variable) | | | 33.99 |
| 13* | −29.799 | 2.45 | 1.64220 | 22.4 | 32.60 |
| 14* | −36.954 | (Variable) | | | 32.01 |
| 15 | ∞ | (Variable) | | | 40.00 |
| Image Plane | ∞ | | | | |

ASPHERIC DATA
2nd Surface
K = 0.00000e+00 A 4 = 1.69495e−05
3rd Surface
K = 0.00000e+00 A 4 = −2.25538e−05 A 6 = 1.10363e−07
4th Surface
K = 0.00000e+00 A 4 = 1.84867e−05 A 6 = 4.87965e−08
5th Surface
K = 0.00000e+00 A 4 = 2.43219e−05 A 6 = −8.32956e−09
6th Surface
K = 0.00000e+00 A 4 = 4.10263e−06 A 6 = 1.29454e−09
7th Surface
K = 0.00000e+00 A 4 = 2.43219e−05 A 6 = −8.32956e−09
8th Surface
K = 0.00000e+00 A 4 = 1.84867e−05 A 6 = 4.87965e−08
9th Surface
K = 0.00000e+00 A 4 = −2.25538e−05 A 6 = 1.10363e−07
10th Surface
K = 0.00000e+00 A 4 = 1.69495e−05
11th Surface
K = 0.00000e+00 A 4 = −2.25538e−05 A 6 = 1.10363e−07
12th Surface
K = 0.00000e+00 A 4 = 1.84867e−05 A 6 = 4.87965e−08
13th Surface
K = 0.00000e+00 A 4 = 2.43219e−05 A 6 = −8.32956e−09
14th Surface
K = 0.00000e+00 A 4 = 4.10263e−06 A 6 = 1.29454e−09
VARIOUS DATA
Zoom Ratio 1.00
FOCAL LENGTH 17.36

### Numerical Example 8

UNIT: mm
SURFACE DATA

| | | | | | Effective |
|---|---|---|---|---|---|
| Surface No. | r | d | nd | νd | Diameter |
| 1 (Pupil Surface) | ∞ | (Variable) | | | 4.00 |
| 2* | −69.184 | 2.00 | 1.63550 | 23.9 | 28.82 |
| 3* | −52.006 | 5.36 | 1.53500 | 55.7 | 31.70 |
| 4* | −25.055 | (Variable) | | | 34.21 |
| 5* | −31.851 | 2.31 | 1.63550 | 23.9 | 37.06 |
| 6* | −41.815 | −2.31 | 1.63550 | 23.9 | 39.05 |
| 7* | −31.851 | (Variable) | | | 38.46 |
| 8* | −25.055 | −5.36 | 1.53500 | 55.7 | 38.10 |
| 9* | −52.006 | −2.00 | 1.63550 | 23.9 | 37.94 |
| 10* | −69.184 | 2.00 | 1.63550 | 23.9 | 37.66 |
| 11* | −52.006 | 5.36 | 1.53500 | 55.7 | 35.92 |
| 12* | −25.055 | (Variable) | | | 35.07 |
| 13* | −31.851 | 2.31 | 1.63550 | 23.9 | 33.37 |
| 14* | −41.815 | (Variable) | | | 32.52 |
| 15 | ∞ | (Variable) | | | 40.00 |
| Image Plane | ∞ | | | | |

ASPHERIC DATA
2nd Surface
K = 0.00000e+00 A 4 = 1.51661e−05
3rd Surface
K = 0.00000e+00 A 4 = 4.16683e−05 A 6 = −2.59322e−08
4th Surface
K = 0.00000e+00 A 4 = 2.50626e−05 A 6 = 3.94993e−08
5th Surface
K = 0.00000e+00 A 4 = 2.31654e−05 A 6 = −5.92361e−09
6th Surface
K = 0.00000e+00 A 4 = 3.36551e−06 A 6 = 1.52421e−09
7th Surface
K = 0.00000e+00 A 4 = 2.31654e−05 A 6 = −5.92361e−09
8th Surface
K = 0.00000e+00 A 4 = 2.50626e−05 A 6 = 3.94993e−08
9th Surface
K = 0.00000e+00 A 4 = 4.16683e−05 A 6 = −2.59322e−08
10th Surface
K = 0.00000e+00 A 4 = 1.51661e−05
11th Surface
K = 0.00000e+00 A 4 = 4.16683e−05 A 6 = −2.59322e−08
12th Surface
K = 0.00000e+00 A 4 = 2.50626e−05 A 6 = 3.94993e−08
13th Surface
K = 0.00000e+00 A 4 = 2.31654e−05 A 6 = −5.92361e−09
14th Surface
K = 0.00000e+00 A 4 = 3.36551e−06 A 6 = 1.52421e−09
VARIOUS DATA
Zoom Ratio 1.00
FOCAL LENGTH 17.72

Table 1 summarizes values of inequalities (1) to (4), distance L1, focal length F, and effective diameter D in each numerical example. In inequalities (1) and (2), the value of inequality (1) is described for the example in which the second lens and the third lens are cemented, and the value of inequality (2) is described for the example in which the first lens and the second lens are cemented.

TABLE 1

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Inequality (1) | 33.3 | 33.3 | 33.3 | 32.1 | 32.1 | 33.3 | — | — |
| Inequality (2) | — | — | — | — | — | — | 33.3 | 31.8 |
| Inequality (3) | 0.83 | 0.77 | 0.72 | 0.83 | 0.80 | 0.83 | 0.72 | 0.74 |
| Inequality (4) | 0.35 | 0.32 | 0.34 | 0.39 | 0.37 | 0.41 | 0.33 | 0.33 |
| L1 | 13.96 | 12.19 | 11.27 | 13.82 | 14.04 | 18.00 | 12.54 | 13.03 |
| F | 16.89 | 15.89 | 15.62 | 16.64 | 17.45 | 21.59 | 17.36 | 17.72 |
| D1 | 40.00 | 37.59 | 32.90 | 35.70 | 38.32 | 43.51 | 38.51 | 39.05 |

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each example can provide an optical system that is small and has high optical performance.

This application claims the benefit of Japanese Patent Application No. 2023-008501, filed on Jan. 24, 2023, which is hereby incorporated by reference herein in its entirety.

What is claimed is:

1. An optical system configured to guide a light beam from a display surface to a pupil surface, the optical system comprising, in order from a pupil surface side to a display surface side:
a first lens having a first transmissive reflective surface on the pupil surface side;
a second lens; and
a third lens having a second transmissive reflective surface on the display surface side,
wherein the second lens is cemented with the first lens or the third lens, and
wherein the light beam from the display surface transmits through the second transmissive reflective surface, transmits through the third lens, the second lens, and the first lens in this order, is reflected by the first transmissive reflective surface, transmits through the first lens, the second lens, and the third lens in this order, is reflected by the second transmissive reflective surface, transmits through the third lens, the second lens, and the first lens in this order, transmits through the first transmissive reflective surface, and enters the pupil surface.

2. The optical system according to claim 1, wherein the second lens is cemented with the third lens.

3. The optical system according to claim 2, wherein the following inequality is satisfied:

|vd3−vd2|>5.0
where vd2 is an Abbe number of the second lens based on d-line, and vd3 is an Abbe number of the third lens based on the d-line.

4. The optical system according to claim 1, wherein the second lens is cemented with the first lens.

5. The optical system according to claim 4, wherein the following inequality is satisfied:

|vd1−vd2|>5.0
where vd1 is an Abbe number of the first lens based on d-line, and vd2 is an Abbe number of the second lens with respect to the d-line.

6. The optical system according to claim 1, wherein the following inequality is satisfied:
0.60<L1/F<1.00
where L1 is a distance from a surface on the pupil surface side of the first lens to the display surface, and F is a focal length of the optical system.

7. The optical system according to claim 1, wherein at least one surface of the first lens, the second lens, or the third lens is an aspheric surface having an inflection point.

8. The optical system according to claim 1, wherein at least one surface of the first lens, the second lens, or the third lens is a flat surface.

9. The optical system according to claim 1, wherein the following inequality is satisfied:
0.25<L1/D<0.50
where L1 is a distance from a surface on the pupil surface side of the first lens to the display surface, and D is a largest effective diameter among the first lens, the second lens, and the third lens.

10. The optical system according to claim 1, wherein the first transmissive reflective surface is a reflective polarizer.

11. The optical system of claim 1, wherein the second transmissive reflective surface is a reflective polarizer.

12. The optical system according to claim 1, wherein a distance between the first lens and the third lens changes during diopter adjustment.

13. The optical system according to claim 1, wherein a distance between the third lens and the display surface changes during diopter adjustment.

14. A display apparatus comprising:
the optical system according to claim 1,
a display element including the display surface.
